(19) United States
(12) Patent Application Publication
(10) Pub. No.: US 2014/0344266 A1
(43) Pub. Date: Nov. 20, 2014

(54) DEVICE INFORMATION USED TO TAILOR SEARCH RESULTS

(71) Applicant: Broadcom Corporation, Irvine, CA (US)

(72) Inventors: James Duane Bennett, Hroznetin (CZ); Yasantha Nirmal Rajakarunanayake, San Ramon, CA (US); Wael William Diab, San Francisco, CA (US); Brian Wacter, Ladera Ranch, CA (US)

(73) Assignee: Broadcom Corporation, Irvine, CA (US)

(21) Appl. No.: 13/930,731

(22) Filed: Jun. 28, 2013

Related U.S. Application Data
(60) Provisional application No. 61/824,912, filed on May 17, 2013.

(51) Int. Cl. G06F 17/30

(52) U.S. Cl. CPC G06F 17/30554
USPC 707/734

(57) ABSTRACT

Biasing of search results based on device profile and activity data. In various embodiments, biasing operations are performed on search results generated in response to a search query received from a client device. The biasing operations are based on device profile data associated with the client device. Such data may indicate media consumption capabilities of the device or other device hardware and software configuration details. In some embodiments, device activity/sensor data may likewise be employed to bias search results. Biasing operations may include, for example, ranking, prioritizing, or filtering search results to favor results that may be consumed by a client device. Translated and/or targeted and supplemental information may also be provided based on device profile data or user profile data. In certain embodiments, searching and biasing operations may be performed by an intermediary or proxy device.

### CROSS REFERENCE TO RELATED PATENTS/PATENT APPLICATIONS

### Provisional Priority Claims

The present U.S. Utility Patent Application claims priority pursuant to 35 U.S.C. §119(e) to the following U.S. Provisional Patent Application which is hereby incorporated herein by reference in its entirety and made part of the present U.S. Utility Patent Application for all purposes:

1. U.S. Provisional Patent Application Ser. No. 61/824,912, entitled “SEARCH INFRASTRUCTURE EMPLOYING DEVICE CAPABILITY INFORMATION TO TAILOR SEARCH RESULTS,” filed May 17, 2013, pending.

### BACKGROUND

1. Technical Field

The disclosure relates generally to search engine infrastructures, including tailoring search results produced by search engines based on client device profile data.

2. Description of Related Art

A vast and ever-increasing amount of information, documents and other resources are available via the Internet. In order to access such resources, a keyword-based search query is typically entered into a search engine interface or web browser on a client device such as a laptop computer, smartphone, tablet device, web-enabled television, set top box (STB), etc. The search engine then examines its index/search databases, and presents a set of search results (or “web documents”). These search results are typically ranked by algorithms employed by the search engine, such that the “best” results are presented first. Each result in a listing of search results may include a short summary containing a web document's title and excerpts of text in order to suggest its relevancy.

In order to generate and maintain search databases, conventional search engine infrastructures employ web crawlers (also known as “spiders”) that examine or “crawl” web hosting servers to gather web page text and associated media content. A typical web crawler follows every link on a given web page. The contents of such pages are analyzed for purposes of indexing and extracting search database content for use in responding to search queries.

Various techniques have been implemented or proposed for improving the quality and ranking of presented search results. For example, a search engine provider may collect and store information relating to a particular user, including previously submitted search inquiries and browsing history, for use in influencing the manner in which search results are presented. Certain other historical behavioral information may be utilized, such as user clicks on previous search result pages and advertisements from search result pages.

### BRIEF DESCRIPTION OF THE SEVERAL VIEWS OF THE DRAWINGS

FIG. 1 shows an exemplary network employing search result biasing functionality.

FIG. 2 is a block diagram of an exemplary search system.

FIG. 3 is a functional block diagram representation of exemplary client device interaction with a search infrastructure.

FIG. 4 illustrates an exemplary search engine infrastructure employing assorted activity data and device consumption data.

FIG. 5 is an operational flow diagram illustrating an exemplary method for biasing a set of search results.

FIG. 6 is an operational flow diagram illustrating an exemplary method for tailoring search results based on device consumption data.

FIG. 7 is a functional block diagram representation of an exemplary residential network supporting search biasing operations.

FIG. 8 is a schematic block diagram of an example client device supporting search result biasing operations.

FIG. 9 is a screen shot illustrating an exemplary search query interface supporting user-specified biasing operations.

### DETAILED DESCRIPTION

In various embodiments of the technology described herein, search infrastructure and methodologies are provided to support biasing of search results based on device profile and/or activity data. In some embodiments, biasing operations are performed on a set of search results generated in response to a search query (or search request) received from or on behalf of a client device. The biasing operations may be based on device profile data associated with the client device and/or a user of the client device. Such device profile data may indicate, for example, media consumption capabilities or other device hardware and/or software configuration details of the client device. In this manner, search results can be ranked, prioritized, filtered or otherwise biased to favor results that may be more likely to be consumed by a particular client device or otherwise meet the objectives of a given search query.

In other embodiments, device activity data extracted from a client device (such as data generated by one or more device sensors) may likewise be employed to refine search results or perform predictive search operations. Activity data might include, for example, a current location, time, motion-related data (e.g., speed, acceleration, altitude, and/or direction), previous device interactions, e.g., with websites or payment systems, etc. Translated and/or targeted and supplemental information based on device profile data and/or user profile data may also be included in search results. In some other implementations, search results can be biased based at least in part on a combination of device profile data and device activity data. Various other novel biasing operations are described in greater detail below.

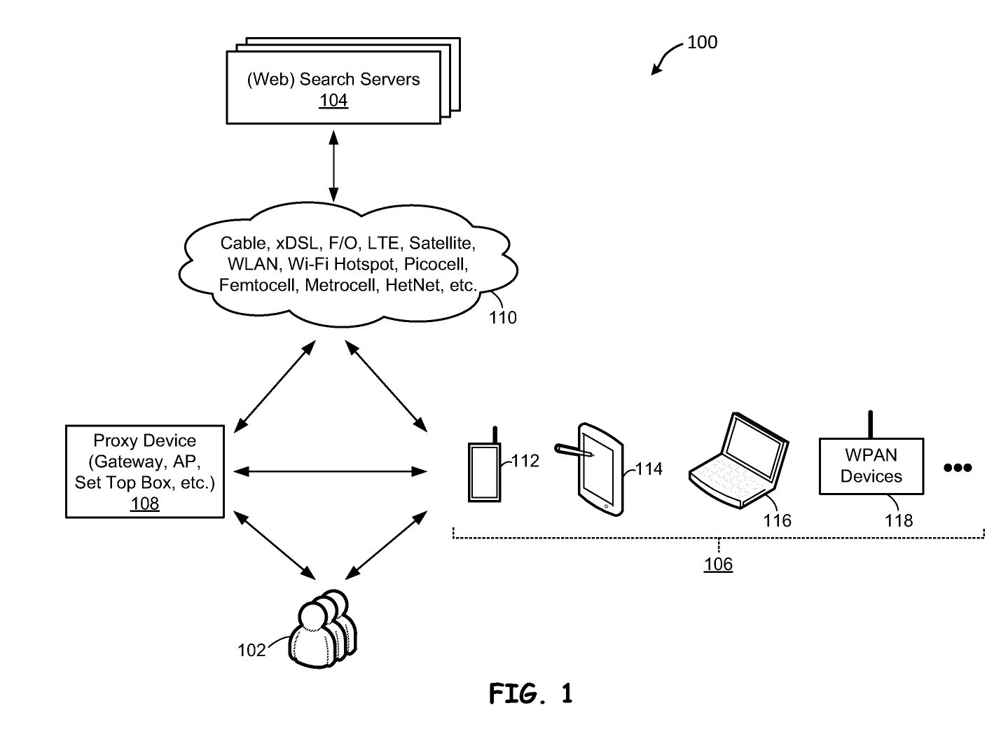

Referring more particularly to FIG. 1, a network 100 employing search result biasing is shown. As shown, one or more users 102 submit search queries, receive search results and otherwise interact with search servers 104. The search servers 104 may be web-based, private or public, local, distributed or a combination thereof. The users 102 may communicate with the search servers 104 via a variety of devices or combination of devices, such as client devices 106 and intermediary or proxy devices 108.

Client devices 106 may include, for example: mobile phones/smartphones 112; tablet devices 114; desktop and laptop computers 116; wireless personal area network (WPAN) devices 118 and other wireless/wired network devices; wearable computers (e.g., heads-up display (HUD) glasses) and other known or future computing devices with communication capabilities; audio/video media consumption devices; and other types of devices capable of communicating search queries and/or receiving search results. Additionally, in certain embodiments, interactions with search servers 104—including both user-initiated and automated interactions—may involve one or more proxy devices 108, such as gateway devices, access points, STBs, etc.

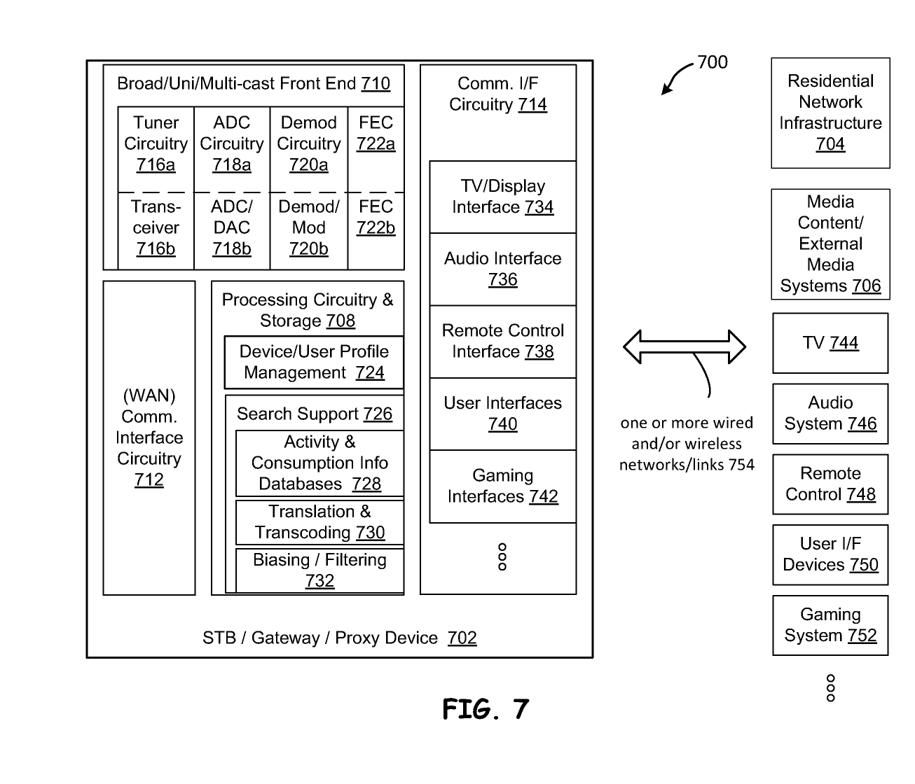

By way of example, and as described more fully below, a search query can be input through a client device 106. The search query may then be communicated to the search servers 104 via a proxy device 108 (such as that described below in conjunction with FIG. 7). Likewise, search results generated by the search servers 104 may be communicated through a proxy device 108 for consumption by a client device 106. In certain embodiments, a search query submitted to search servers 104 may originate from or be entered through a proxy device 108 on behalf of one or more client devices 106. In further embodiments, a proxy device 108 may operate as a client or consuming device. Biasing of search results may be performed by server-side devices, client-side devices, or a combination thereof.

In the illustrated embodiment, communications between the search servers 104, client devices 106 and proxy devices 108 occur via one or more wired and wireless communication links 110. The communication links 110 may utilize, for example, one or more of various transmission media—such as coaxial cable, shielded twisted pair cable, fiber-optic cable, power line wires, and wireless media (radio frequencies, microwave, satellite, infrared, etc.)—and operate in accordance with a variety of communication and networking protocols (TCP/IP, UPnP, IPv6, etc.) and standards (3G, 4G, IMT-Advanced, DOCSIS, xDSL, Wi-Fi/802.11x, WiMax, Bluetooth, etc.). In addition, the communication links 110 may comprise a picocell, femtocell, metrocell, heterogeneous network (HetNet) and/or multi-hop network utilizing a spanning tree protocol, direct wireless connections, peer-to-peer links, etc.

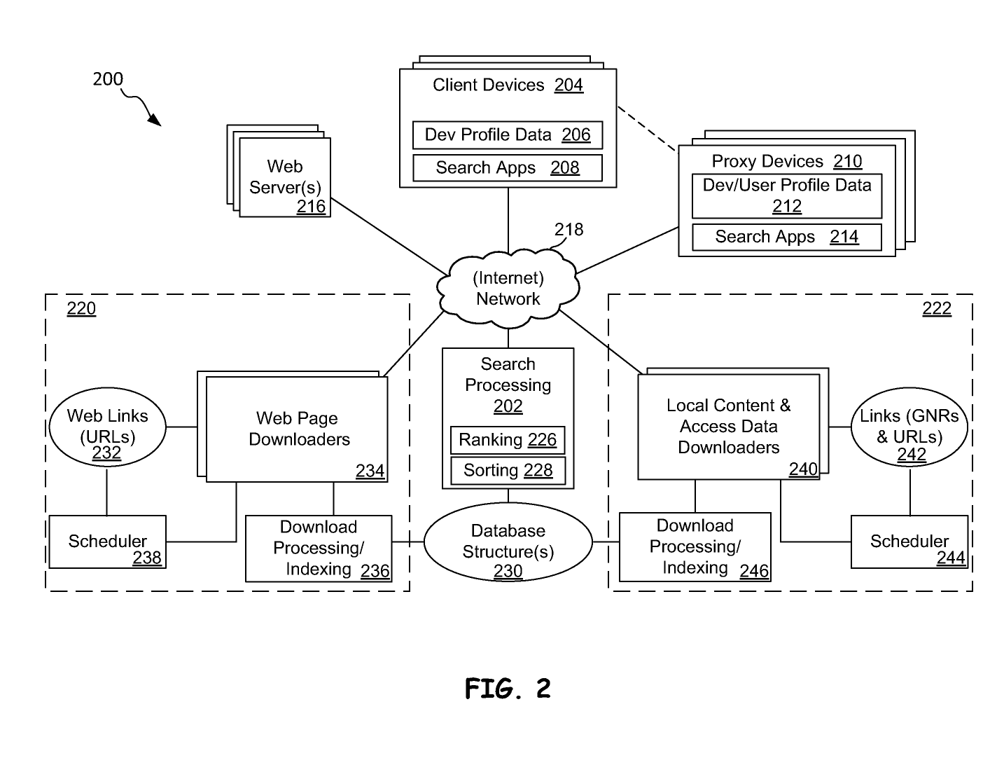

FIG. 2 is a block diagram of one example of a search system 200. The search system 200 includes one or more search processing computers 202 (e.g., web-based servers) capable of biasing search results based, e.g., on either or both of hardware and software characteristics of client devices 204 and/or proxy devices 210. Biasing of search results may include, for example, individual ones or combinations of (re)ranking 226, sorting 228, filtering, culling, restricting, and other tailoring operations that favor search results that are compatible with or may be consumed by recipient devices, or (using predictive operations) are most likely to be consumed by recipient devices. It is noted that in certain embodiments, biasing operations may entail selectively searching and generating results from search databases and/or portions of search databases that are selected, weighted, etc., based on data associated with a recipient device.

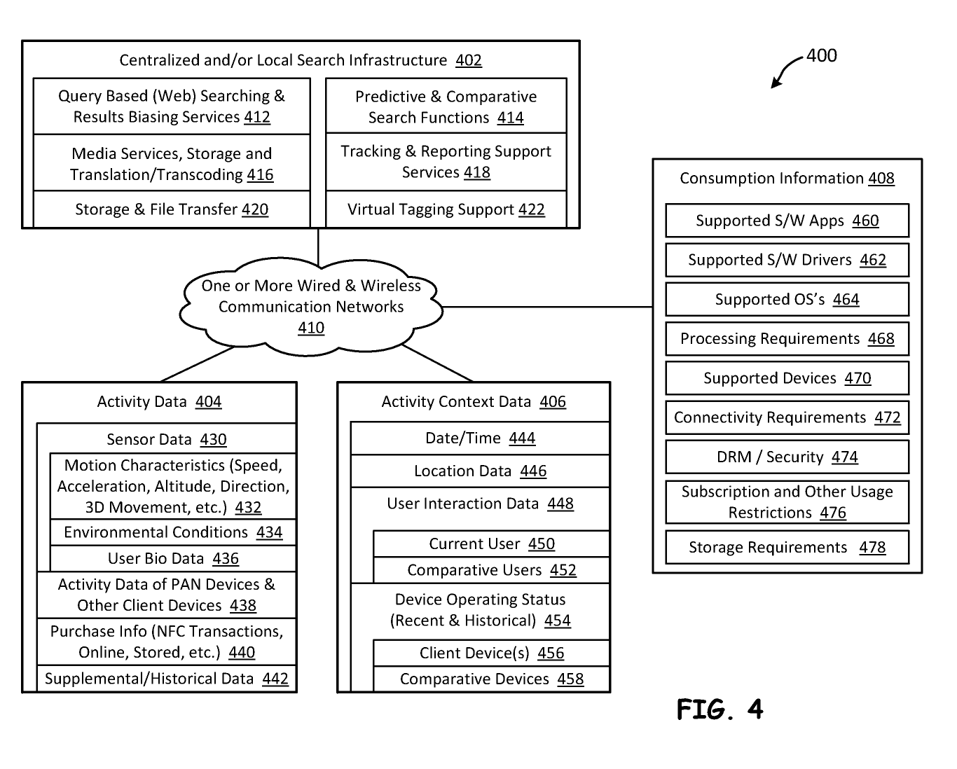

Device profile data 206 provides an indication of the capabilities (e.g., make, model, ID, configuration, supported applications, etc.) and/or activity data associated with client devices 204, such as described more fully in conjunction with FIG. 4. Client devices 204 may further include search-enabled program code or application software 208 (e.g., a user search interface in a web browser or media player) for generating search queries and receiving search results. Similarly, proxy devices 210 can include device/user profile data 212 relating to the proxy devices 210, the client devices 204, and/or users of such devices. Proxy devices 210 may also host search-enabled application software 214, including program code to enable search operations on behalf of or for the benefit of other devices.

In certain contemplated embodiments, the device profile data 206 and device/user profile data 212 may be generated in whole or part through execution of scanning or diagnostic tools hosted by a client device or search infrastructure. In other embodiments, device profile data may be supplied through or supplemented by user input operations or user profile/sub-profile data. As described herein, such device profile data may be communicated to or compiled by search processing computers 202 in a variety of ways, either in conjunction with or independent of specific search queries, for use in tailoring search results. As noted, biasing operations based on such data may be performed by one or more of client devices 204 and proxy devices 210 in lieu of or in addition to the search processing computers 202. In certain embodiments, (additional or initial) tailoring of search results may occur following selection of one or more search results for use by a client device 204, such as when a particular search result is available in a plurality of formats and device profile data 206 indicates that a certain format(s) is more readily consumed by the recipient device.

Briefly, as used herein the term “web page” generally refers to a web document or other web resource that is accessible through a web browser and can be presented on a client device. Web pages, which may be retrieved from a local computer or from a remote web server can be in any format, e.g., HyperText Markup Language (HTML) or Extensible HTML (XHTML) format, and may provide hypertext links for navigation to other web pages. Further, as used herein, the term “web document” refers to something that has a uniform resource identifier (URI) (often classified as uniform resource locators (URLs), as uniform resource names (URNs), or as both) and can respond to requests by returning a representation(s) of an identified resource.

A web crawler 220 systematically browses or “crawls” the World Wide Web hosting servers for the purpose of building a database of web-based content. Web crawler 220 uses a list of web links 232, such as URLs, as seeds for a process of content discovery. As the crawler visits these URLs, one or more web page downloader(s) 234 parse the URLs to identify unique hyperlinks in the page which point to content stored in web servers 216. URLs are typically visited in a recursive manner according to a set of policies which detect structure and content. As links are traversed, web pages and specific content are downloaded by downloader(s) 234 as per a schedule dictated by scheduler 238.

A download processing/indexing module(s) 236 operates to perform reverse indexing of a selected web page to encode web page words (e.g., based on frequency) and note location on the associated page (offset) so that content can be recovered or extracted at a later time. The indexed data is transferred to a search engine database structure(s) 230, where it is stored for later access by the search processing computers 202. In various embodiments of the present disclosure, search processing computers 202 receive Hypertext Transfer Protocol (HTTP) sequences and/or user input search strings from a client device 204 (e.g., smartphone, tablet, laptop, desktop computer or other known or future client devices with communications capabilities) and/or proxy device 210 parses/hashes database structure(s) 230 to retrieve, for example, data, text, images, video, software, links, etc., and to tailor/bias search results.

Briefly, database structures 230 typically include indexes of unique words with associated index pointers (URLs) and web page position information. Unique words are hashed using a hash table. A hash table (or hash map) is a data structure used to implement an associative array, a structure that can map keys to values. A hash table uses a hash function to compute an index into an array of buckets or slots, from which the correct value can be found. Unique words are typically arranged by frequency (e.g., highest to lowest) and also carry importance based on a frequency ranking. In a search context involving the phrase “the cat”, for example, the word “the” is generally not important while the word “cat” is important. Rare words are often given highest importance along with strings of words and rare strings of words.

Various elements of search system 200 are interconnected by a network 218 (e.g., an Internet backbone network) that is implemented using known and future communication infrastructures such as wireless and wired networks including, but not limited to, wireless local area networks (WLANs), wide area networks (WANs), local area networks (LANs), Ethernet, fiber optic or other known or future communication network infrastructures. Web servers 216 are accessible via the network 218, and host various web pages and associated content processed by the web crawler 220 and the search processing computers 202.

A local crawling system 222 may also be provided to access and process local or private content in support of searching and biasing operations. Such local content might include, for example, personal media libraries or image databases, backup files and cached content, content stored on networked devices, virtual tag content and access data, etc. This content may or may not be available in a markup language format, e.g., HTML or XHTML.

In operation, the local crawling system 222 performs in a like manner to the web crawler 220. For example, the local crawling system 222 can access and parse stored geolocation virtual tags in much the same way a traditional web crawler would crawl a web page. The illustrated local crawling system 222 includes, but is not limited to: one or more local content and access data downloader(s) 240; links or pointers 242 (such as URLs or global network routes (GNRs)) which identify unique routes that will guide a future search request to relevant content or portions of content; scheduler 244 to schedule the crawling of the local or client-hosted content; and a download processing/indexing module(s) 246 to process and (reverse) index data and content for storage in databases such as database structure(s) 230.

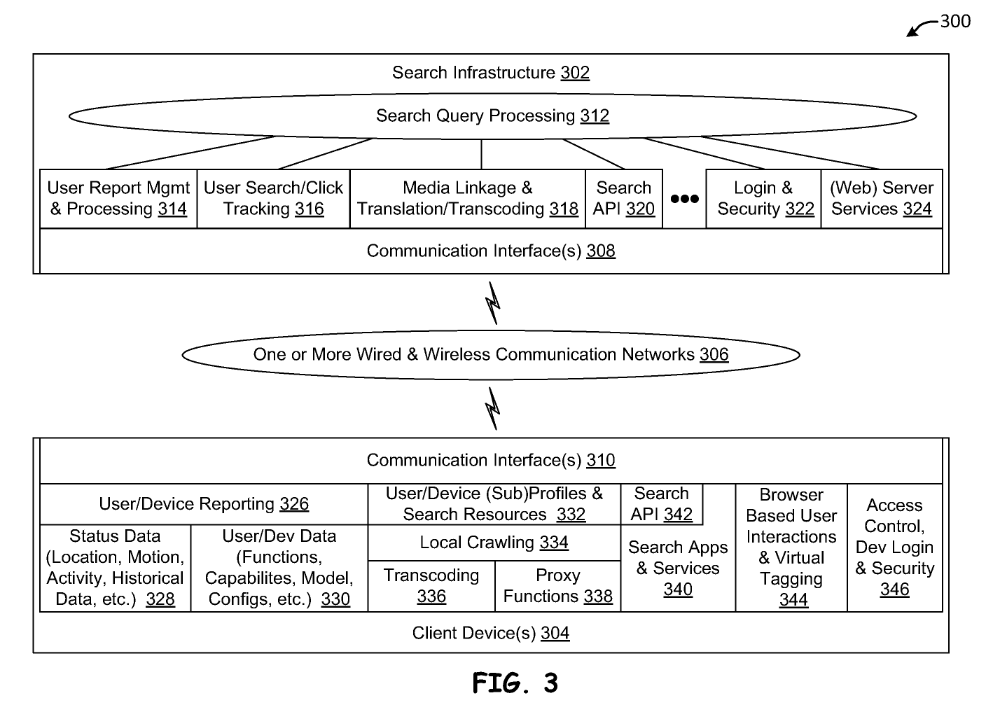

FIG. 3 is a functional block diagram representation 300 of exemplary client device interaction with a search infrastructure 302. A client device(s) 304 includes communication interface(s) 310 for communicating with the search infrastructure 302 through communication interface(s) 308. Such communications may occur via one or more wired and wireless communication networks 306.

Various functions of the search infrastructure 302, including search query processing 312, may be implemented by centralized infrastructure (e.g., a web- or cloud-based search service accessed via the Internet in a client-server arrangement), distributed infrastructure (e.g., a local area network in which various nodes participate in search operations), or some combination thereof. Likewise, some functions may be implemented by cloud-based servers and storage devices, client devices, intermediary or proxy devices, and/or various combinations of such devices.

As illustrated, search query processing 312 may incorporate a variety of functionality to support biasing of search results, including user report management and processing 314 and user search/click tracking 316 (to maintain device and user profile data), media linkage and translation/transcoding 318, and a search application programming interface (API) 320 to support service-specific search applications and services 340 that utilize a corresponding API 342. Search query processing operations may be conditioned on login and other security measures 322. Additional (web) server services 324 may be supported by the search infrastructure 302, such as search-related advertising services and the like.

The client device 304 includes user/device reporting functionality 326 for gathering and reporting a wide range of information, including status data 328 and user/device data 330, either or both of which can be used in biasing search results and performing predictive search operations. As set forth in greater detail in conjunction with FIG. 4, status data 328 may include any or all of location data, motion data, historical data and other activity information. User/device data 330 can indicate, for example, device functions and capabilities, model and make, software configurations, etc.

While using a client device, for example, a user may log into a user account and elect to automatically or manually provide capability data for the device to be stored along with the user's profile data. In some embodiments, such capability data might be considered a device sub-profile within a user profile, thereby allowing multiple device profiles to coexist within a higher level profile. In some instances, merely providing make and model information for a client device may be sufficient if such make and model's characteristics are already known to the search service/provider that is maintaining the user profile. Similarly, only device characteristics that differ from a standard device profile may need to be identified. Thereafter, logging into a user account may also involve underlying client device identification information so that the appropriate profile can be maintained and utilized.

In other embodiments, device and/or user profile data (e.g., user/device (sub-) profiles and search resources 332) may be maintained on the client side and submitted in whole or part each time a search result is sought. Changes to device capability data over time may result in automatic or scheduled updates to the associated device sub-profile. Accordingly, a set top box, music player, DVD player, smart TV, smartphone, tablet device, or any other device from which a user might initiate a web content search might store all relevant device sub-profiles under an overall user profile. Then, with the same search query, the user may receive a different set of biased search results tailored to the capabilities of the device from which the search was submitted (or a device identified as a consuming device).

For example, a search query using the word “Stones” might return results that include highly positioned “Rolling Stones” MP3 file offers when submitted from a device used to playback audio, e.g., an MP3 player. The exact same web search terms submitted from a set top box might return results in which “Oliver Stone” movie streaming offers that are in full HD consumable formats are more prominently featured, while searching through a personal computer might provide unbiased “Stones” related information, and so on.

The illustrated client device 304 supports local crawling operations 334 for identifying local or non-web based content, transcoding capabilities 336 and other proxy functions 338. In addition, the client device 304 may also support browser-based user interactions with the search infrastructure 302, as well as virtual tagging operations 344. Briefly, virtual tagging provides users with the ability to create geolocation virtual tags for various objects and locations throughout the world. Geo-augmentation by geolocation virtual tagging can facilitate, via hand-held devices (smartphones, cameras, tablets, etc.), annotation of various geolocations around the world. A geolocation virtual tag (virtual tag) might include, for example, a text note praising a restaurant, a photo taken atop the Eiffel Tower at night, a vacation video and text note, a text note on a hiking trail advertising a local café, an advertisement from a business in close proximity to the user, or the like. Each of such virtual tags, upon posting, receives an associated geolocation. A supporting infrastructure may store each virtual tag posting element along with its associated geolocation for access by searching infrastructures.

For example, upon receiving a location-based search query (e.g., involving a GPS location of a first mobile communications device), the search infrastructure 302 may apply the location information to a search database, yielding a search result including any geolocation virtual tags having a geolocation in proximity (e.g., less than 200 yards/meters) to location information. Such identified geolocation virtual tags can then be delivered from storage to a searching (mobile) device for presentation.

The client device 304 further provides access control, device login and security functionality 346. In some embodiments, the client device 304 may participate in a login process associated with an overall user profile. For example, an automated device login procedure (e.g., an SSL type interaction that occurs in the background) coupled with a user login process can be utilized to identify applicable profile data for use in biasing operations.

FIG. 4 illustrates an exemplary search engine infrastructure 400 employing assorted activity data and device consumption information. Centralized client/server or local/distributed search infrastructure 402 provides query based (web) searching and results biasing services 412 and predictive and comparative search functions 414. These search and biasing operations may utilize one or more of activity data 404, activity context data 406 and consumption information 408 communicated over one or more wired and/or wireless communication networks 410.

For example, activity data 404 and/or activity context data 406 is provided by or extracted from a client device to help enable more accurate user activity predictions and to refine or supplement search results. Such data may include sensor data 430 such as motion characteristics/data 432 (e.g., speed, acceleration, latitude, direction, three dimensional movement, etc.), environmental conditions 434 (e.g., temperature and humidity), user biometric data 436, etc. Other relevant activity data 404 may include activity data 438 relating to PAN devices and other devices associated with a user, purchasing information 440 (e.g., prior NFC transactions and online/stored purchase histories provided by various websites), and other supplemental and historical data 442. Activity context data 406 may include, e.g., one or more of the following: data and time information 444, location data 446 (e.g., from a device GPS module, media access control (MAC) address, Internet protocol (IP) address, or the like), previous user interaction data 448 (for a current user 450 and/or comparative users 452), and previous device operating status data 454 (for a given client device(s) 456 and/or comparative client devices 458).

For example, sensor data 430 can be utilized in predictive search operations to bias search results or to trigger a search query. Such prediction might involve, for example, detecting that when a user captures images with a smartphone on weekends while walking, the images typically involve architectural content. If the user tends to launch an image search shortly thereafter, he/she may generally favor certain photo sites for viewing matching images. Based on such correlations, if the user is walking, e.g., through a city and captures an image, the smartphone may be configured to immediately preprocess the image for search querying.

If the user then opens or begins interacting with a search query interface, the smartphone may begin uploading the image while prompting the user for confirmation that such image is to be utilized. If the user confirms, the image upload may continue, and the resulting search results can be biased to favor the preferred photo sites. It is noted that motion characteristics 432 and other sensor data 430 can be used in tailoring search results associated with any type of searching (virtual tags, normal web searching, predictive search result production, etc.).

In another example in which context regarding a user's activity is derived from a particular device over time, a set top box might provide details regarding a user's Thursday night viewing and search habits (e.g., preference for a particular science fiction series). Over time, by merely pulling up a search query interface provided by the set top box, results (which may be pre-downloaded) including the preferred television series may be offered.

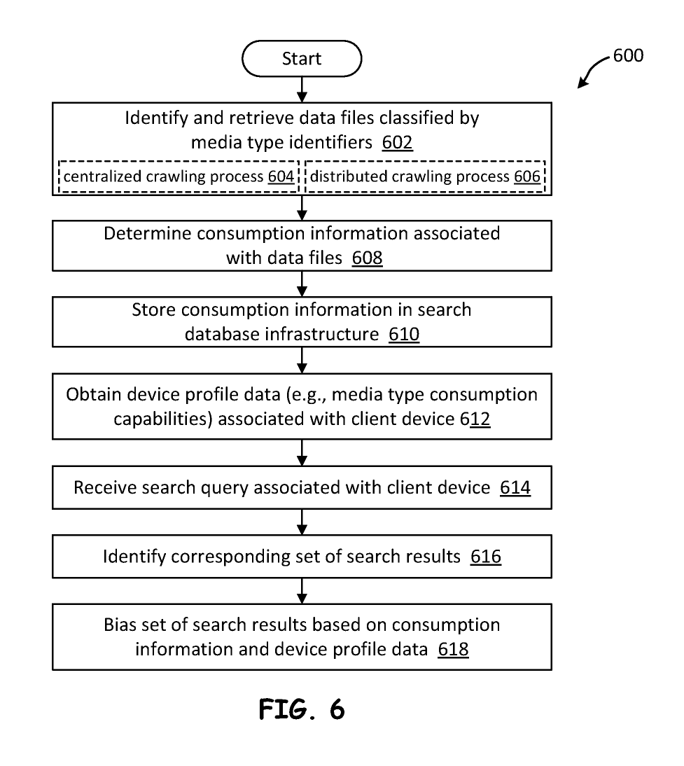

In still further embodiments (such as described more fully below in conjunction with FIG. 6), consumption information 408 is compiled for searchable data files and/or client devices for use in search result biasing operations. Without limitation, such information may relate to supported software applications 460 and supported software drivers 462, supported operating systems 464, processing requirements 468, supported devices 470, connectivity requirements 472, digital rights management (DRM) and other security requirements 474, subscription-based requirements and other usage restrictions 476, storage requirements 478, etc.

In addition, the search infrastructure 402 can provide additional functionality to support search result biasing and related operations, including media-related services (such as media file storage and translation/transcoding functions) 416 and tracking and reporting support services 418 (e.g., for managing activity data 404 and activity context data 406). The search infrastructure 402 further supports general storage and file transfer services 420, such as caching of device hosted content, as well as virtual tagging support 422.

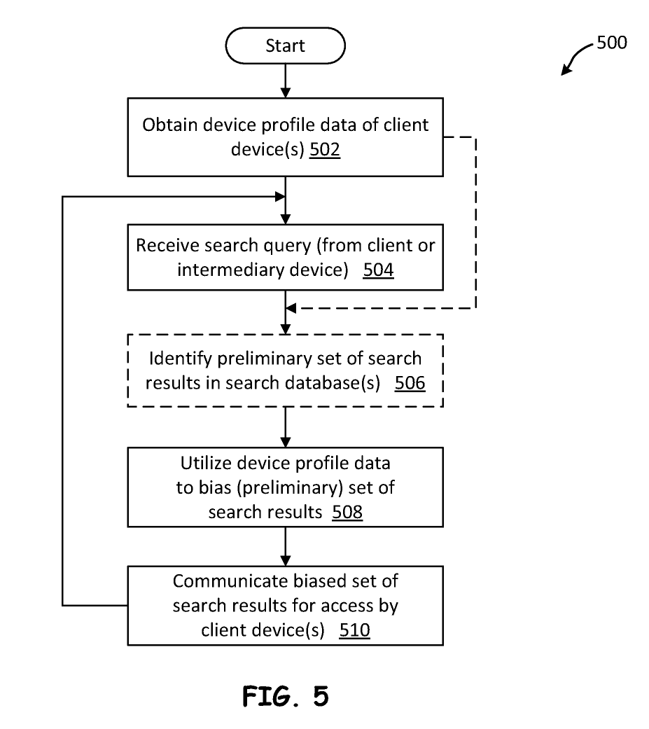

Referring now to FIG. 5, an operational flow diagram of an exemplary method 500 for biasing a set of search results is illustrated. In this method, device profile data is obtained for one or more client devices (502). When a search infrastructure receives a search query from or on behalf of such a client device (504), the search infrastructure identifies a preliminary set of search results in an associated search database(s) (506).

Next, the device profile data is utilized (either by the search infrastructure and/or device(s) associated with the client device) to bias the preliminary set of search results (508) for use by the client device. The biased set of search results is then communicated for access by the client device (510). Supplemental and/or locally hosted information may also be appended to or identified within the biased set of search results. Such information may include, for example, targeted advertising based on device and/or user profile data, alternate search results, etc. It is also noted that in certain embodiments, the device profile data may be refreshed or expanded following receipt of a search query (as indicated by the dashed line of FIG. 5).

FIG. 6 is an operational flow diagram illustrating an exemplary method 600 for tailoring search results based on device consumption information. In this method, crawling processes are utilized to identify and retrieve data files classified by media type identifiers (602). The crawling processes may involve one or more of centralized crawling processes 604 and distributed crawling processes 606, such as those described in conjunction with FIG. 1.

Consumption information associated with the data files is determined (608). This consumption information can be stored (610) in a search infrastructure database for use in subsequent search result biasing operations. In particular, device profile data associated with a client device—including media consumption capabilities of the client device—is determined (612). When a search query associated with the client device is received (614), a corresponding set of search results is identified (616) by the search infrastructure. These search results are then biased (618) based at least in part on either or both of the consumption information and device profile data. As noted below, in some implementations biasing operations may be utilized to generate the initial set of search results in block 616. Further biasing based on consumption information and/or device profile information may occur following selection of one or more of such search results.

In some embodiments, method 600 may be performed using a centralized processing approach in which a search service provider utilizes a crawling process to exercise web page links and gather data files of various types (e.g., images, video, program code (compiled and uncompiled), word processing files, spreadsheets, etc.). A gathered data file can be analyzed to identify information relating to consumption requirements for the file including any or all of, as contextually appropriate, required software applications (and versions thereof), required operating systems, processing requirements, device model numbers and configurations, screen resolutions, audio capabilities, keypad/keyboard capabilities, peripherals, wired and wireless connectivity requirements, hardware, software, MIME type equivalents/expansions such that requirements of consuming devices can be identified, etc.

As is known, the term “Internet media types” or “media types” (sometimes also referred to as “MIME types” or “Content Types”) refers to standardized identifiers for file formats on the Internet. A media type is generally comprised of two or more parts, including a type and a subtype (such as video/mpeg), and is defined in HTML by the “type” attribute on links, objects, and script and style tags. Media types defined by MIME standards include image, text, video, audio, application, message, model, etc.

In some embodiments, searchable web pages and/or content files (or information derived from such web pages and/or content files) may be organized into database “buckets” or slots corresponding to one or more of various consumption requirements, MIME types, device and/or software types, etc. Biasing operations may then include utilizing device profile data and/or device activity data to determine which buckets to search, prioritize buckets to be searched, etc. For example, content from certain database buckets may be accorded a relatively higher weighting factor (e.g., a factor of eight on a scale of one to ten) or otherwise prioritized when creating a set of search results for consumption by a particular type of device, such as a tablet computer. Other database buckets might be ignored or assigned a lower weighting factor.

In addition, translation (including transcoding) of certain data files into other formats may be performed. For example, search history or volume information relating to a data file may indicate a need or preference to translate the data file and support an alternate format or formats. Translation may be from any representation to another, including from one programming language to another, from one operating system to another, from one file resolution to another, etc. In some embodiments, all trusted sources of application software and drivers that can consume the translated data files are also identified and stored. Sources of data files (as well as associated billing and DRM information) may also be stored along with the data file or data file identifier.

A distributed approach may also be employed wherein consumption information is gathered by a web server and/or client hosting device. This consumption information (and possibly data files themselves and/or translations thereof) may then be delivered, either through a centralized crawling process or via push/pull operations, to a central search database structure. In one embodiment, consumption information gathered in this manner is merged with consumption information gathered via a centralized crawling process(es).

In further embodiments, search processing may entail use of real time or stored client device capability data to impact filtering/biasing of search results. For example (and with reference to a prior example), a search query using the word “Stones” from a device representing a user's DVD player might include information relating to the DVD player make and model, system speaker configuration and video capabilities, a home network arrangement, supported standards, user configuration data, etc. That is, the search input could be “Stones” plus one or more items of system capability information. In addition, system usage history (overall or per family member user) might also be conveyed (e.g., title, artist, year, consumed history, consumption frequency, etc.). This information may be submitted along with a search query, or stored and periodically updated by a central search infrastructure.

In the latter approach, the search query might include the term “Stones” along with device and/or user identification information. The search infrastructure may then only need to access the device's profile data (and possibly user profile data) in order to return search results that are tailored for the particular device or current operating environment of the device. For example, if profile data indicates that a consuming device has a low battery charge, a relatively low frame rate version of a movie file might be returned. Likewise, if the device is engaged in other activities or otherwise unavailable to consume a file, the file might be downloaded for later consumption.

In other embodiments of search result biasing, a search infrastructure supports a variety of commercial sites offering streamed audio/video, software applications, and/or other consumable items. For example, a central search infrastructure can support such sites by: i) identifying all site offerings and associated consumption information; ii) gathering all user account information from such site and correlating such information with the search infrastructure's user accounts; iii) appending or otherwise supplementing the search infrastructure's user account information (profile, usage history, personal data, etc.) with that received from the offerings site (bidirectional sharing of information might also occur); iv) gathering all approved device information (including profiles, history, capabilities, limitations, etc.) from such offering sites; and v) biasing/filtering search results based on such gathered information such that a user can be presented with, e.g., exclusively, search results (or prioritized search results) from such offering sites that the user or user's device or system is likely to want and/or be capable of consuming.

In still further embodiments wherein first devices are configured/authorized to pair with certain second devices, search results may be biased to promote selection of such pairings via Internet pathways. Such first and second devices may both be clients or servers, or combinations thereof. For example, profile data may allow pairing of an STB, DVD carousel player, NAS media server and like devices to one or more smartphones, e.g., belonging to one or more family members, for slinging-type operations. In such an example, a family member might then visit a search site, enter a query for “stone,” select his/her smartphone as the consuming device, select personalization (or user profiling) options, and then submit the search query.

In this example, responsive search results might favor a “Rolling Stones” CD offer via a DVD carousel player, an “Oliver Stone” movie via a NAS media server, and then a collection of Internet-hosted items that can be consumed by the family member's smartphone. By further selecting to restrict the search results to “software programs,” biasing/filtering operations yield different search results where, for example, a Rosetta Stone language translation application tailored for the searcher's native tongue, geolocation, and smartphone are offered near the top of the search results. If the consumption type is changed to “spreadsheet”, search results might favor or highlight a price list (in spreadsheet format) from a natural stone sales site, along with an offer for a spreadsheet application or other compatible reader application tailored for the relevant smartphone. The searcher may elect to download the application with or without the actual content, or vice versa. If one or more local applications capable of consuming relevant content are already present, this information may also be included in the search results. Thereafter, by selecting the content, the application could be launched (or downloaded from a local source if not already present). If multiple applications are available for consuming a particular type of content, one of the applications may be selected based on historical user preferences. Payment infrastructure and/or DRM licensing management may also be present and supported within the search infrastructure.

Search results may be presented to a user in a variety of ways. For example, a video may be identified in a list of search results through a clip or excerpt that is tailored for display on a relevant device. With respect to program code results, excerpts of code may be presented along with copyright information, descriptive information, etc. Similarly, a spreadsheet file may be identified via an image of a relevant excerpt or sheet of the spreadsheet such that the underlying file need not be opened in order to determine relevancy to a searcher. In some implementations, search results may be translated for use by a particular device or class of devices.

FIG. 7 is a functional block diagram representation of an exemplary residential network 700 supporting search biasing operations. A device 702, such as a communication device, STB or gateway, provides a number of search support functions, and may operate as a gateway or intermediary device that supports unidirectional or bidirectional search-related communications and bridging between client/network devices.

The device 702 interacts with a residential network infrastructure 704 and external media systems 706 via one or more wired and/or wireless networks/links 754. The networks/links 754 may utilize one or more of various transmission media—such as coaxial cable, shielded twisted pair cable, fiber-optic cable, power line wires, etc.—and operate in accordance with a variety of communication and networking protocols (TCP/IP, UPnP, IPv6, etc.). In addition, the networks/links 754 may comprise a multi-hop network utilizing a spanning tree protocol, direct wireless connections, peer-to-peer links, etc.

The external media systems 706 may comprise, for example, one or more of cable, satellite and/or terrestrial televisions systems. Various headend equipment and services can be utilized by these systems, such as a cable headend that receives television signals for further processing and distribution, and may offer various other services such as Internet connectivity (e.g., to external search infrastructures) and VoIP services.

The device 702 of the illustrated embodiment includes a broadcast/unicast/multicast front end 710 that operates in part to communicate search queries to and receive search results from search service providers. The front end 710 further operates to receive uncompressed and/or compressed digital video, digital audio and other data signals, from either or both of the external media systems 706 and residential network infrastructure 704, for further processing and distribution. The front end 710 comprises tuner circuitry 716a operable to isolate particular channels. Signals from the tuner circuitry 716a are provided to analog-to-digital (ADC) circuitry 718a and demodulation circuitry 720a for conversion into binary format/stream. Further, forward error correction (FEC) circuitry 722a can check the integrity of the received binary stream. Audio, video, and data extracted from the binary stream may then be decoded (e.g., by search support 726) into one or more formats suitable for consumption by downstream devices. It is noted that demodulation circuitry 720a may support one or more modulation techniques, such as Quadrature Phase Shift Keying (QPSK), Quadrature Amplitude Modulation (QAM), Coded Orthogonal Frequency-Division Multiplexing (COFDM), etc.

The front end 710 may be integrated into one or more semiconductor devices that may further support, for example, interactive digital television, networked DVR functionality, IP video over DOCSIS applications, and 3D graphics support. In addition, multiple tuner circuitry 716a (including in-band and out of band tuners), ADC circuitry 718a and demodulation circuitry 720a may be provided for different modulation schemes and television standards (such as PAL, NTSC, ATSC, SECAM, DVB-C, DVB-T(2), DVB-H, ISDB, T-DMB, Open Cable).

In some alternative embodiments, functionality of the device 702 is performed by a smartphone or mobile computing device (e.g., a tablet device or laptop computer). In such embodiments, the “front end” 710 comprises one or more wireless interfaces (including PHY and baseband functions), such as a cellular (3G, 4G, IMT-Advanced, etc.) or wide area network (HetNet, Wi-Fi, WiMax, etc.) interface. The interface may support one or more modulation and multiplexing techniques, such as OFDM, OFDMA, SC-FDMA, QPSK, QAM, 64QAM, CSMA, MIMO, etc. In the illustrated embodiment, the wireless interface comprises a transceiver 716b, analog-to digital (ADC) and digital-to-analog (DAC) circuitry 718b, demodulation and modulation circuitry 720b and FEC (such as turbo codes or LDPC codes) circuitry 722b.

The illustrated device 702 also includes WAN/LAN communication interface circuitry 712 for communicating with residential network infrastructure 704 and/or external media system 706. Through the communication interface circuitry 712, the device 702 may communicate directly with external searching services and other upstream resources, or offer (bidirectional) bridged communications between such resources and devices coupled to the device 702.

In the example of FIG. 7, device 702 interacts with a variety of devices 744-752 over one or more wired and/or wireless communication channels via communication interface circuitry 714. For example, a television or display interface module 734 communicates with a (digital) television 744 or other media display device to relay television programming and enable available interactive services. In certain embodiments, the television or display interface module 734 might include a remote user interface (RUI) server. Similarly, an audio interface 736 provides audio programming or audio library access to an audio system 746.

The communication interface circuitry 714 further comprises a remote control interface 738 for receiving control signals from a remote control 748. In addition to traditional remote control operations, the remote control 748 may further offer voice and/or gesture control signals that are relayed or mapped to relevant consumer devices. User interfaces 740 are also provided for communications with one or more user interface devices 750. Gaming interfaces 742 function to provide interactive communications with a gaming system 752. Such communications may involve, for example, online, multiplayer gaming between members of a social network and/or external players in a gaming platform. As will be appreciated, various devices 744-752 may support full or limited search querying and/or search result consumption capabilities.

The device 702 includes processing circuitry and storage capabilities 708 (components of which may be comprised of hardware, software, or combinations thereof) to support searching and biasing operations. In particular, device/user profile management functionality 724 may serve to generate, maintain, and/or communicate profile data (such as configuration data for one or more coupled devices).

The device 702 further includes search support resources 726, which may include various functions such as activity and (device or data file) consumption information databases 728, translation/transcoding functionality 730, and search result biasing and/or filtering capabilities 732. In operation, such search support resources 726 enable the device 702 to function as an intermediary device capable of reformatting received search results, filtering or otherwise biasing search results (including partial or additional biasing), assisting in translation services for end point consumption devices, managing DRM and payment collection, etc. It is noted that the processing circuitry and storage capabilities 708 may be made available in whole or part as a resource for external service providers, networked devices, etc.

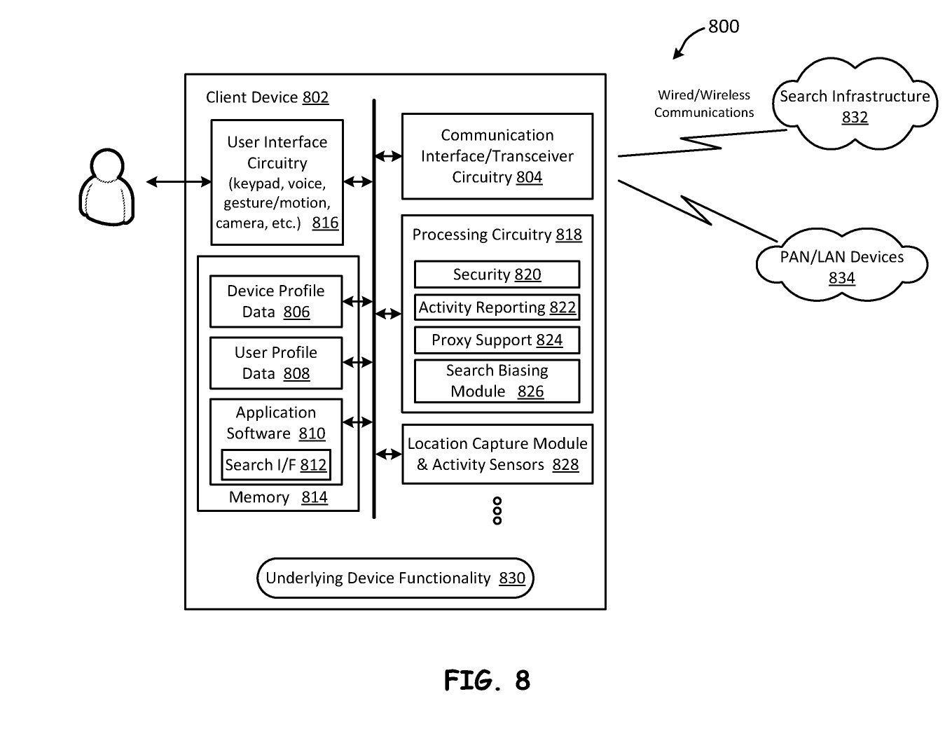

FIG. 8 is a schematic block diagram of an exemplary embodiment of a user (or client) device 802 that supports search result biasing operations. The client device 802 is shown in a wired and/or wireless network 800 that includes a search infrastructure 832 and one or more personal area network (PAN)/LAN devices 834. The client device 802 communicates with such elements of the network 800 via communication interface and transceiver circuitry 804. These communications may be unilateral or bidirectional/interactive, and may utilize proprietary and/or standardized communication protocols. Communications may include, for example, search queries and search query results, profile and activity data for use in biasing search query results, control signals, audio/video content, relayed information, etc.

The client device 802 of the illustrated embodiment further includes processing circuitry 818 operable to process and manage search operations such as those described above. More particularly, the processing circuitry 818 may include, for example, a security module 820, an activity reporting module 822, a proxy support module 824, and a search biasing module 826. The client device 802 further includes location capture module and activity sensors 828 in order to generate activity data for use in search result biasing operations, virtual tagging functions (such as described above), etc. A location capture and activity sensors module 828 may include, for example, GPS capabilities, Wi-Fi positioning support, or other technologies capable of generating device location data.

The client device 802 further incorporates device profile data 806, user profile data 808 and application software 810 having one or more search interfaces 812. Each of elements 806-810 may take many forms, and is maintained in static or dynamic memory 814. As noted, device profile data 806 enables a client device to present an image of itself and/or its capabilities for use in performing various search result biasing operations. Depending on the capabilities and requirements of a particular device or device user, a device or user profile may be static or dynamic.

In certain embodiments, the client device 802 may interact with a user(s) via user interface circuitry 816. User input to the client device 802 may include, for example, search query data entry through a keypad, touchscreen, remote control device, gaming controller, device control buttons, voice or gesture commands, camera, storage device, etc. Authorized access to or control of the client device 802 can be facilitated through unique biometric identifiers, passwords, token-based identification, trusted authorities or documents such as a driver's license or passport, and like authentication mechanisms.

The client device 802 may perform core or underlying functionality 830 (e.g., social networking functions, social appliance functions, mobile communications, security, vehicular communications, etc.). Alternatively, the client device may primarily function as a search interface and/or search result consumption device.

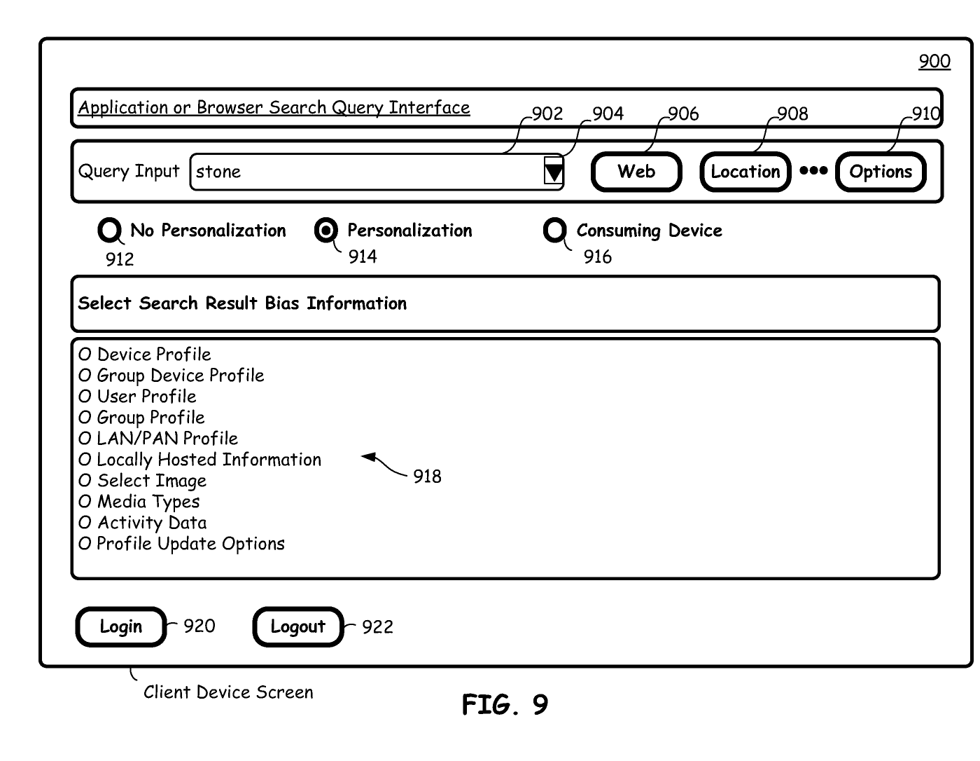

FIG. 9 is a screen shot illustrating an exemplary search query interface 900 supporting user-specified biasing operations. The search query interface 900 may be presented on a client device screen (e.g., smartphone or tablet device), on a display incorporated in or attached to a proxy device (e.g., a set top box), or on other types of devices capable of performing search query operations. Further, the search query interface 900 may be defined by a stand-alone application or program code, part of a larger client device software application or a hosted/cloud-based application, displayed through a web browser, etc.

In the illustrated configuration, the search query interface 900 includes a query input field 902 for entering search query terms (text, images, etc.). A drop down menu 904 may be included to allow a user to select previous search queries, suggested search queries, and the like. Option buttons 906-910 are provided to allow a user to specify search parameters, such as web-based search button 906 and location-based search button 908. Other searching parameters may be presented to a user by clicking option button 910.

With respect to biasing of search results, various fields or radio buttons are provided to allow a user to select traditional searching (no personalization) 912 or personalization 914 (e.g., using one or more of search result bias information options 918). In some implementations, biasing of search queries and/or search results may be automatically performed, e.g., based on a preference election. An additional radio button 916 may be provided to allow a user to selectively provide an indication (e.g., through a sub-menu) of consumption capabilities and user preferences associated with an intended recipient or consuming device for use in biasing (or further biasing) of search results.

For example, the search query interface 900 may be displayed on a laptop computer, but the user may select to tailor search operations (including the generation and presentation of an initial set of search results and/or retrieval and delivery of selected search results) to favor items capable of being displayed by a particular television or other media consumption device. By clicking on or otherwise selecting an item in set of search results, for example, a user may be offered: a version of an item formatted for the consumption device; secure payment processing; direct delivery to a consuming device; indirect/proxy delivery through the laptop or other device; software and/or software upgrades (operating system, applications, drivers, etc.) required to consume an identified item; associated consumption metadata including ratings, descriptions, consumption information, etc.; and opportunities to rank or socially link an item.

In the illustrated embodiment, in which personalization 914 of search results is selected, the user is presented with a variety of search result bias information options 918 for use in biasing search results and/or search queries, including real time, predictive and/or background searching operations. Such bias information options may include, by way of example, one or more of device profile data, group device profile data, user/group profile data, LAN/PAN profile data (e.g., communication capabilities of networked or intermediary devices), locally hosted information, specified images, media types, activity data, etc. The search query interface may be configured to support selection of other types of data, such as those described in conjunction with FIG. 4. Selection of a given option may result in display of additional or related options, such as a sub-menu that allows selection of one of a plurality of available device profiles or group profiles.

In some implementations, search results may be biased based on an association, either explicit or inferential, in a particular group. For example, search results can be biased based on selections made by other members of a searcher's group (or a group the searcher aspires to) of results presented in response to similar search criteria. Relevant groups may be defined based on demographic information, self-identification in a user profile, attributes to which a user aspires, etc.

Other possible elements of the search query interface 900 include a login option button 920 (e.g., for accessing a specific user account) and a logout option button 922. It is noted that the specific look and feel of the search query interface 900 is not considered critical, and many variations in both presentation and range of options are possible.

As may be used herein, the term “associated with”, includes direct and/or indirect association of separate items and/or one item being embedded within another item. As may also be used herein, the terms “processing module”, “processing circuit”, and/or “processing unit” may be a single processing device or a plurality of processing devices. Such a processing device may be a microprocessor, micro-controller, digital signal processor, microcomputer, central processing unit, field programmable gate array, programmable logic device, state machine, logic circuitry, analog circuitry, digital circuitry, and/or any device that manipulates signals (analog and/or digital) based on hard coding of the circuitry and/or operational instructions. The processing module, module, processing circuit, and/or processing unit may be, or further include, memory and/or an integrated memory element, which may be a single memory device, a plurality of memory devices, and/or embedded circuitry of another processing module, module, processing circuit, and/or processing unit. Such a memory device may be a read-only memory, random access memory, volatile memory, non-volatile memory, static memory, dynamic memory, flash memory, cache memory, and/or any device that stores digital information. Note that if the processing module, module, processing circuit, and/or processing unit includes more than one processing device, the processing devices may be centrally located (e.g., directly coupled together via a wired and/or wireless bus structure) or may be distributed (e.g., cloud computing via indirect coupling via a local area network and/or a wide area network). Further note that if the processing module, module, processing circuit, and/or processing unit implements one or more of its functions via a state machine, analog circuitry, digital circuitry, and/or logic circuitry, the memory and/or memory element storing the corresponding operational instructions may be embedded within, or external to, the circuitry comprising the state machine, analog circuitry, digital circuitry, and/or logic circuitry. Still further note that, the memory element may store, and the processing module, module, processing circuit, and/or processing unit executes, hard coded and/or operational instructions corresponding to at least some of the operations and/or functions illustrated in one or more of the Figures. Such a memory device or memory element can be included in an article of manufacture.

The present disclosure includes method descriptions illustrating the performance of specified functions and relationships thereof. The boundaries and sequence of these functional building blocks and method operations have been defined herein for convenience of description. Alternate boundaries and sequences can be defined so long as the specified functions and relationships are appropriately performed. Any such alternate boundaries or sequences are thus within the scope and spirit of the claims. Similarly, flow diagram blocks may also have been defined herein to illustrate certain significant functionality. To the extent used, the flow diagram block boundaries and sequence(s) could have been defined otherwise while still performing the certain significant functionality. Such alternate definitions of both functional building blocks and flow diagram blocks and sequences are thus within the scope and spirit of the claimed subject matter. One of average skill in the art will also recognize that the functional building blocks, and other illustrative blocks, modules and components herein, can be implemented as illustrated or by discrete components, application specific integrated circuits, processors executing appropriate software and the like or any combination thereof.

The present disclosure may have also been described, at least in part, in terms of one or more embodiments. A physical embodiment of an apparatus, an article of manufacture, a machine, and/or of a process may include one or more of the aspects, features, concepts, examples, etc. described with reference to one or more of the embodiments discussed herein. Further, from figure to figure, the embodiments may incorporate the same or similarly named functions, steps, modules, etc. that may use the same or different reference numbers and, as such, the functions, steps, modules, etc. may be the same or similar functions, steps, modules, etc. or different ones.

Unless specifically stated to the contrary, signals to, from, and/or between elements in a figure of any of the figures presented herein may be analog or digital, continuous time or discrete time, and single-ended or differential. For instance, if a signal path is shown as a single-ended path, it also represents a differential signal path. Similarly, if a signal path is shown as a differential path, it also represents a single-ended signal path. While one or more particular architectures are described herein, other architectures can likewise be implemented that use one or more data buses not expressly shown, direct connectivity between elements, and/or indirect coupling between other elements as recognized by one of average skill in the art.

The term “module” is used in the description of the various embodiments of the present disclosure. A module includes a processing module, a functional block, hardware, and/or software stored on memory for performing one or more functions as may be described herein. Note that, if the module is implemented via hardware, the hardware may operate independently and/or in conjunction with software and/or firmware. As used herein, a module may contain one or more sub-modules, each of which may also contain one or more sub-modules.

While particular combinations of various functions and features of the present disclosure have been expressly described herein, other combinations of these features and functions are likewise possible. The present disclosure is not limited by the particular examples disclosed herein and expressly incorporates these other combinations.

What is claimed is:

1. A method for biasing search results, the method comprising:
obtaining device profile data corresponding to a device associated with a search query, the device profile data including at least one of device hardware information and device software information;
identifying, via a search database, a set of search results corresponding to the search query;
biasing the set of search results based, at least in part, on the device profile data to produce biased search results; and
outputting the biased search results.

2. The method of claim 1, further comprising:
obtaining user profile data corresponding to a user associated with the search query, wherein biasing the set of search results is further based on the user profile data.

3. The method of claim 1, the device profile data including data regarding media consumption capabilities of the device, wherein biasing the set of search results includes ranking the search results to give preference to results that may be consumed by the device, as indicated by the device profile data.

4. The method of claim 1, the device profile data including data regarding media consumption capabilities of the device, wherein biasing the set of search results includes filtering the search results to exclude or conceal results that are unsuited for consumption by the device, as indicated by the device profile data.

5. The method of claim 1, the search query originating from a second device, wherein obtaining device profile data includes receiving an indication of the relevant profile data from the second device.

6. The method of claim 1, wherein obtaining device profile data comprises an automated login process involving the device.

7. The method of claim 1, the device profile data further including device activity data.

8. The method of claim 7, the device activity data including motion-related data.

9. The method of claim 1, biasing the set of search results performed, at least in part, by an intermediary device.

10. The method of claim 9, wherein identifying a set of search results is performed by a centralized search infrastructure, the intermediary device further supplementing the set of search results with locally hosted information.

11. The method of claim 1, the search query including a search term and device identification information, the device identification information utilized in obtaining device profile data.

12. The method of claim 1, further comprising:
communicating targeted advertising information to the device in conjunction with outputting the search results, the targeted advertising information based, at least in part, on the device profile data.

13. A method performed by a search service to tailor search results for consumption by a client-side device, the search service having a search database infrastructure, the method comprising:
obtaining device profile data associated with the client device, the device profile data providing an indication of media type consumption capabilities of the client device;
identifying a plurality of data files classified by a plurality of media type identifiers;
determining consumption information associated with the plurality of data files;
storing the consumption information in the search database infrastructure;
receiving a search query associated with the client device; and
identifying a tailored set of search results based on both the search query and device profile data, the tailored set of search results including at least one of the plurality of data files.

14. The method of claim 13, wherein the consumption information includes information regarding supported software applications, supported drivers, supported operating systems, processing requirements, client device requirements, connectivity requirements, or combinations thereof.

15. The method of claim 13, further comprising:
translating the at least one of the plurality of data files to produce a modified data file; and
determining consumption information associated with the modified data file.

16. The method of claim 15, further comprising:
receiving a request for the at least one of the plurality of data files; and
responding to the request by outputting the modified data file.

17. A device having content consumption capabilities, the device comprising:
a communication interface configured to support communications with a search infrastructure;
processing circuitry operably coupled to the communication interface;
memory coupled to the processing circuitry; and
program code stored in the memory, wherein the processing circuitry operates according to the program code to provide a user interface configured to support entry of search queries for submission to the search infrastructure via the communication interface,
the user interface further configured to enable selective communication of the content consumption capabilities of the device to the search infrastructure.

18. The device of claim 17, further comprising:
a location capturing module coupled to the communication interface, the location capturing module configured to generate device location data for use by the search infrastructure.

19. The device of claim 17, wherein the user interface further supports a user login process for the search infrastructure.

20. The device of claim 17, the user interface further configured to enable a user to selectively disable search query processing utilizing the content consumption capabilities of the device.
